(19) United States
(12) Patent Application Publication
(10) Pub. No.: US 2009/0096624 A1
(43) Pub. Date: Apr. 16, 2009

(54) Vehicle seatbelt usage external indicator system

(76) Inventors: Marc Stengel, Owings Mills, MD (US); Jay Gamerman, Baltimore, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,304

(22) Filed: Oct. 11, 2007

(51) Int. Cl. G08B 5/36

(52) U.S. Cl. 340/641

(57) ABSTRACT

A seat belt usage indicator having a seat occupied sensor and a seat belt reel sensor with an externally mounted indicator light. The seat belt usage indicator system has a sensor positioned in each seat and a seat belt reel sensor corresponding to each seat such that the external indicator light can only be deactivated when the seat belt corresponding to an occupied seat is engaged. To ensure reliability, a plurality of surge absorbing devices which protect the circuitry from any voltage spikes that may occur due to static electricity or other disturbances in the vehicle's electrical system, are provided. Also provided are a plurality of resistors which prevent damage to the device by limiting current. In this manner, a reliable and tamper-resistant seat belt usage indicator system is provided.

### BACKGROUND OF THE INVENTION

The present invention relates to a vehicle seatbelt usage indicator system, which indicates externally to the vehicle, whether seatbelts are being used in an operational mode for each of the occupied seats of a vehicle. The vehicle seatbelt usage indicator system allows an external visualization of the operation of the seat belts and can be used by law enforcement personnel to quickly and readily determine whether a vehicle in operation is not using their seatbelts in conformity with local, state, or federal laws.

The subject invention further pertains to a multi seat arrangement for the seatbelt usage indicator system for external monitoring of a vehicle seatbelt usage.

Additionally, the instant invention is directed to a seatbelt actuation system which aids in the determination of seatbelt usage of individuals within a vehicle in order that an external party may easily determine whether occupied seats within a vehicle have respective seatbelts in an operable condition.

Still further, the instant invention relates to a vehicle seatbelt usage indicator system where a light control circuit is electrically connected to a seat occupancy circuit and a seatbelt reel sensor circuit for illuminating a vehicle externally mounted light upon detection of a seat being occupied and the seat belt being in a non-operating mode of operation.

### DESCRIPTION OF THE PRIOR ART

Seat belt sensor technologies in use in modern automobiles are primarily based on Hall effect sensors located in the buckle mechanism. The typical sensor is an open collector type device which will ground a connected circuit when the seat belt is in use. In addition, a “seat occupied” sensor is used to alter the air bag system when a passenger of sufficient weight to activate the sensor sits on the seat.

When a driver or passenger does not use the seat belt, the vehicle typically turns on an indicator lamp on the dash board and may also turn on an audible indicating device to alert the driver and passenger to fasten their seat belts. This alert is typically only employed within the car and is used only for the occupant's benefit—to suggest to them that they employ their seat belts. In some cases the driver may ignore the indicator(s) and even attempt to bypass the sensors by hooking an unused passenger belt into the driver's side buckle to shut off the warning indicator or may use other means to bypass the system. It has even been found by the Department of Transportation that in attempts to bypass these warning systems, some drivers have purchased separate buckles that are severed from the seatbelt, or fashioned crude metal pieces to keep constantly wedged into the belt buckle receptacle and thus silence warnings.

One problem associated with conventional seatbelt warning systems is their susceptibility to tampering.

Another problem associated with conventional seatbelt warning systems is that they solely indicate non-use to the driver—who often is ambivalent about seatbelt usage.

Yet another problem associated with conventional seatbelt warning systems is the high occurrence of false positives, occasioned by electrical malfunctions.

The best art known to Applicant includes U.S. Pat. Nos. 5,877,707; 4,107,645; 3,840,849; 6,239,695; 6,382,667; 6,729,427; 6,809,640; 7,061,375; 6,501,374; 6,357,790; 3,748,639; 5,804,887; and 7,005,976.

Prior art systems such as that shown in U.S. Pat. No. 7,061,375, which is directed to a system for warning of a failure to wear a seatbelt, have a seatbelt lamp warning light and an alarm placed in suitable parts of the instrument panel that operate when the ignition is turned on. If a speed signal is detected, the controller will operate an audio alarm with intermittent sound emission to warn the driver to buckle seatbelts.

U.S. Pat. No. 6,809,640 also provides an audible and visual warning if the seatbelt is uncoupled. Again, however, this warning means is positioned on the dashboard or otherwise, in the driver's line of sight and only intended to alert the driver.

U.S. Pat. No. 4,107,645 is directed to a seatbelt system with an engine starter lock and alarm. This system has a circuit for each seat in the vehicle that provides a seat switch that must first be closed, and then the seatbelt buckled to be deactivated. The means here will prevent someone from leaving a buckle plugged in and sitting on top of it. Only engaging of the seatbelt buckle after sitting in the seat will disengage the alarm which is also intended to warn solely the occupant/driver. In fact, the starter motor is only unlocked when all occupied seats have their seatbelts buckled. So the car cannot be driven at all until all occupied seats have their belts buckled.

U.S. Pat. No. 5,877,707 is directed to a GPS based seat belt monitoring system and method for using the same. This patented system provides a GPS receiver and a system for detecting seat belt usage by the driver and/or occupants which consists of an infrared emitter and receiver with retro-reflective material mounted or embedded within the shoulder harnesses. The detector works by emitting an IR beam in the direction of the IR reflector embedded in the seatbelts. The system assumes that if a beam bounces back—the seatbelt is indeed appropriately fastened. There is also provided an internally mounted indicator light intended to be viewable through the front or rear windshield that is intended to alert law enforcement personnel, and/or other drivers whether the IR beam has been received. Among other distinctions, this system however fails to provide a seatbelt usage detector system that is resilient to tampering, inasmuch as merely taping a piece of aluminum foil to the emitter would bounce the IR beam back and thus signal proper seatbelt usage. This system does not use the seatbelt reel sensor corresponding to a seat occupied sensor system shown in the subject patent application. Further, this system does not show, allude, or suggest any surge protection, or resistance to electrostatic discharge (ESD) that the subject application provides. Still further, this system shows the exact opposite of the subject patent application with regard to indicator light: 1) the indicator light of this system is meant to be illuminated when all seatbelts are properly fastened, whereas the subject patent application indicator illuminates only when the seatbelts are NOT properly in use AND 2) this system suggests only an internally mounted indicator light—whereas, to prevent tampering and aid in visibility, the subject patent application provides for an externally mounted indicator light.

### SUMMARY OF THE INVENTION

The present invention provides a seat belt usage indicator system that prevents tampering, avoids false positive, protects against ESD, and accurately indicates to law enforcement personnel an improper usage of seat belts.

One object of the present of the invention is to provide a seat belt usage indicator system that prevents tampering. The seat belt detector includes a seat occupied sensor and a corresponding seat belt reel sensor. The indicator light is activated when a user sits in a seat. To deactivate the light, the seatbelt reel sensor corresponding to the occupied seat must be extended. Therefore using another belt from the passenger seat to click in or a piece of metal to wedge into the buckle will be ineffectual at deactivating the law enforcement external indicator light. Further, with the usage indicator light being external to the car—it is further removed from tampering by the driver.

It is another object of the present invention to provide a seat belt usage indicator that is resilient against ESD voltage surges and spikes. This is accomplished by providing a plurality of TranZorb® or voltage suppression/absorption devices. As well, a plurality of resistors which will limit the current flow to sensitive instruments are utilized.

It is yet another object of the present invention to provide a seat belt usage indicator system which will prevent tampering with the external indicator light. This is accomplished by firstly mounting the light external to the car and out of reach of the occupants. Secondly, this external mounting provides increased visibility to law enforcement personnel.

### BRIEF DESCRIPTION OF THE DRAWINGS

FIG. 1 is an illustration of an individual seat circuit;

FIG. 2A is a typical installation of a four seat circuit; and

FIG. 2B is continuation of a typical installation of a four seat circuit.

### DETAILED DESCRIPTION OF THE PREFERRED EMBODIMENTS

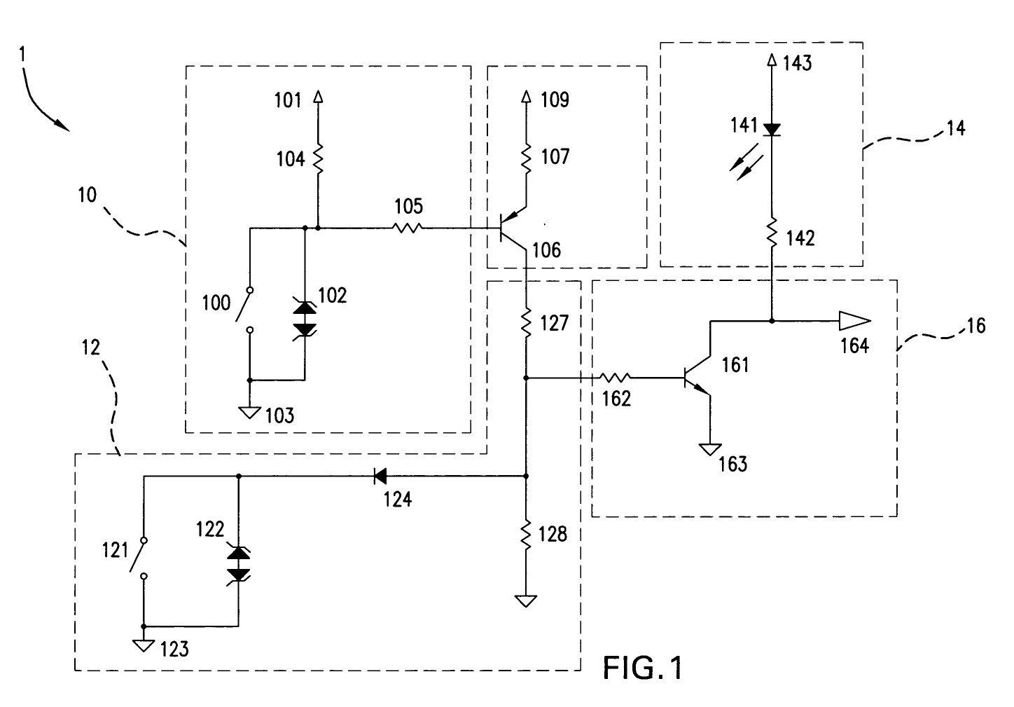

Referring to FIG. 1, there is shown a seat belt usage indicator system (1). The seat belt usage indicator system (1) which includes a seat occupied sensor circuit (10), a seat belt reel sensor circuit (12), a light logic circuit (16) and an indicator light circuit (14). Initially, indicator light circuit (14) has an external indicator light (141), which can optionally be an LED, and is biased OFF.

On engagement of the ignition of the vehicle, voltage is provided across first voltage plus ignition lead (101), second voltage plus ignition lead (109), and third voltage plus ignition lead (143). The circuits are grounded out across first grounding lead (103), second grounding lead (123), third grounding lead (128), and fourth grounding lead (163).

When an occupant sits in a seat, seat occupied sensor (100) of the seat occupied sensor circuit (10) will be closed which will pull the junction of a first resistor (104) and a second resistor (105) to ground.

This grounding of first and second resistors 104 and 105, respectively, will bias a first transistor (106) which is optionally a PNP bipolar junction type transistor to an “ON” state. Therefore current will pass through the first transistor (106) to a third resistor (127) and into the seat belt reel sensor circuit (12).

The current from the first transistor (106), due to the seat being occupied and the ignition engaged, will provide a biasing voltage to a second transistor (161), which is optionally an NPN bipolar junction type transistor, through the third resistor (127) and a fourth resistor (162).

This biasing voltage turns the second transistor (161) ON which will result in the second transistor (161) conducting current to ground through external indicator light (141) and a fifth resistor (142). The current passing to ground through external indicator light (141) will result in external indicator light (141) being illuminated.

With external indicator light (141) of the indicator light circuit system (14) active, this indicates to external viewers such as police or law enforcement personnel that a seat is occupied, the ignition is activated, and yet, no seat belt reel sensor has been activated—which indicates that the seat belt is not being used properly or according to law in the operating and occupied automobile.

External indicator light (141) is preferably a color visible from a far distance and not easily mistakable for headlights, brake lights or turn signals. The external indicator light (141) is preferably located on an exterior of the vehicle in plain sight of law enforcement personnel and other motorists. On sight, Law enforcement officials can then take appropriate action to enforce local laws concerning seat belt use and thus, the overall safety of the roadways is enhanced.

When the external indicator light (141) is activated it is required that the seat belt associated with the occupied seat be used to deactivate the seat belt usage indicator system (1), thus preventing the driver of the vehicle from purposely bypassing the system by other means. In the past, users have sought to bypass other systems by connecting the passenger seat belt to the driver seat buckle thus defeating the system or by jamming a piece of metal into the seatbelt buckle.

However, the subject system is not as easily defeated, since the circuit focuses on the seat belt reel sensor (121) of the seat belt corresponding to the occupied seat, the system is not able to be defeated in this manner. Deactivation of external indicator light (141) requires the activation of a seat belt of the seat belt reel sensor (121) associated with the seat that is currently occupied. Thus, extending the passenger seat into engagement with the driver's buckle will have no effect. Similarly, wedging a piece of metal into the buckle, which could disable a traditional Hall sensor in buckle head type system—will have no effect herein. The subject system could optionally provide for a set range of extension necessary from the seatbelt reel sensor (121) such that the belt must be extended between a minimum and maximum range to de-activate the external indicator light (141). Such a configuration could prohibit a user from simply leaving his seatbelt extended and plugged in to the buckle receptacle and sitting on the seatbelt. Therefore, this system has enhanced resistance to tampering and will provide a more reliable system.

To ensure that this external indicator light (141) is activated only when it is intended to be activated and does not trigger on false positives, a plurality of surge absorbing devices are provided. The first surge absorbing device is shown as element 102 which is coupled in parallel relation with the first seat occupied sensor (100). Optionally, the surge absorbing device (102) is a transient voltage suppression diode (transorb or TranZorb® as known to one skilled in the art). TranZorb is a registered trademark of General Semiconductor and is commercially available.

A second surge absorbing device (122) is coupled in parallel relation to the seat belt reel sensor (121). This second surge suppression/absorption device could also optionally be a transient voltage suppression diode (transorb or TranZorb®).

The first and second surge absorbing devices (102 and 122 respectively) are intended to protect the circuitry from any voltage spikes that may occur due to static electricity or other disturbances in the vehicle's electrical system and therefore ensure continued reliable operation.

To further protect the system, the current through the first transistor (106) is limited by a sixth resistor (107) to prevent damage to the device. The sixth resistor (107) is disposed in line between the second voltage plus ignition lead (109) and the first transistor (106).

A further current limiting resistor, the fifth resistor (142) is provided for the indicator light circuit (14) disposed in-line between the second transistor (161) and external indicator light (141) coupled in series relation thereto. A seventh resistor (128) provides an additional low current path to ground to ensure that the second transistor (161) is biased OFF if the first transistor (106) is in the OFF state to thereby prevent accidental activation of the external indicator light (141) of the indicator light circuit (14).

When the seat belt corresponding to the occupied seat is pulled from its retractor reel, a seat belt reel sensor (121) will close and pull the voltage at the junction of the third resistor (127), fourth resistor (162), and the seventh resistor (128) to ground through a blocking diode (124) provided in line and coupled in series relation to the seat belt reel sensor (121) and the second surge absorbing device (122).

This will result in the second transistor (161) being biased to the OFF state which will in turn result in external indicator light (141) of the indicator light circuit (14) being deactivated. Thus, in normal operation when the ignition is engaged, the seat is occupied, and the seat belt has been extended from the seat belt reel corresponding to the occupied seat, there is no light indicia. The absence of illumination of external indicator light (141) indicates that the seat belt is not being used improperly. Oppositely, when the usage indicator light is illuminated, this indicates that there is improper seatbelt usage.

If the vehicle occupant attempts to bypass the seat belt usage indicator system (1) by inserting a seat belt from an unoccupied passenger seat in the driver side buckle or using some other type of device in an attempt to defeat the system, the second transistor (161) will still be biased ON because seat belt reel sensor (121), corresponding to the seat occupied sensor (100) has not been closed. Therefore, this tampering will still result in the external indicator light (141) being on.

Optionally, seat occupied sensor (100) and seat belt reel sensor (121) can be Hall effect type sensors. Further, seat occupied sensor (100) and seat belt reel sensor (121) could be open collector Hall effect type sensors. Alternatively, pressure or weight switches could be used.

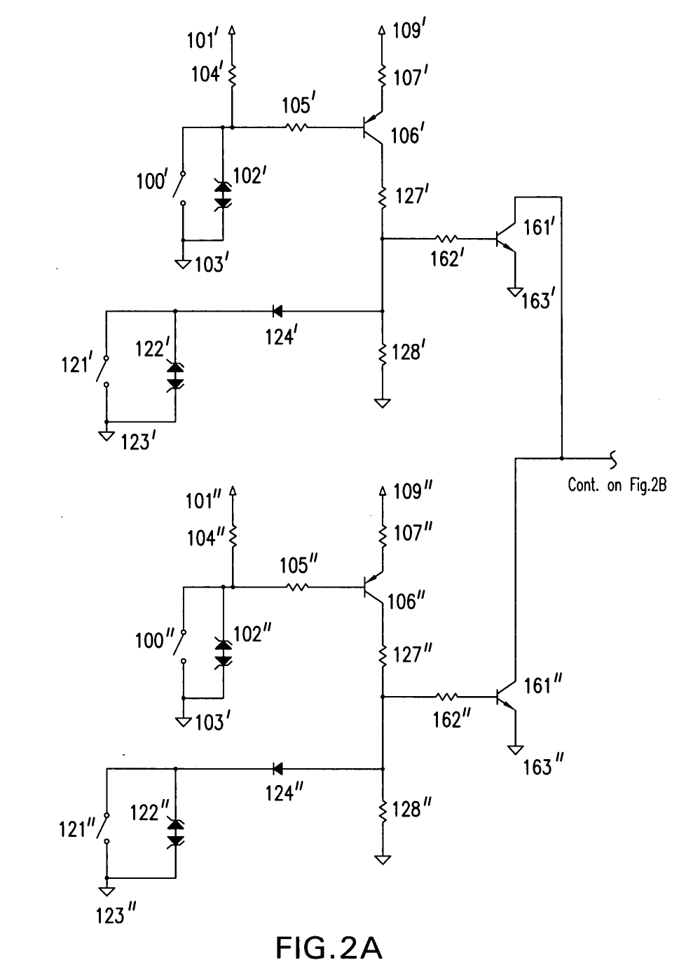

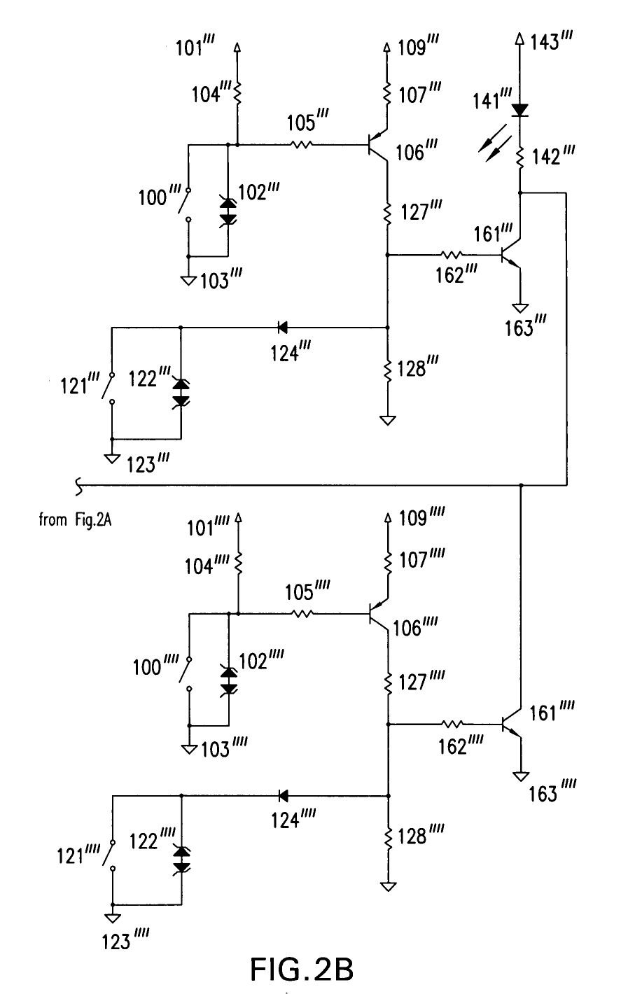

As can be seen in FIG. 1, lead (164) will accept input from other seat sensor circuits. A plurality of seat sensor circuits in a wired OR is shown in FIG. 2 where a positive logic state/ON of any of the light logic circuits (16) of the plurality of seats will illuminate the external indicator light (141). A plurality of the seat sensor circuits as shown in FIG. 1 can be connected together. With them connected together, if any one of the seats are occupied without a corresponding seat belt being extended, then external indicator light (141) of light circuit (14) will be activated. A plurality of seat occupied sensor circuits (10), each provided with a respective seat belt reel sensor circuit (12) and a respective light logic circuit (16), are all connected in a wired OR to a single external indicator light (141). Alternatively, each combination of seat occupied sensor circuit (10), seat belt reel sensor circuit (12) and light logic circuit (16) could be provided with it's own indicator light circuit (14). Therefore, a plurality of seats can be provided with the reliable seat belt usage indicator system described herein.

As can be seen in FIGS. 2A and 2B, a plurality of the seat belt usage indicator circuits are coupled in a wired OR relation sharing an external indicator light (141′″), voltage plus lead (143′″), and resistor (142′″). The indicator light circuit, which is identical to the indicator light circuit (14) of FIG. 1, has one external indicator light (141′″), however, a plurality of external indicator lights could be provided. Additionally, an audio indicator system, tactile, or internal indicator lights could also be provided. Additional/alternative indicator means will be readily apparent to those skilled in the art.

The plurality of seat belt usage indicator circuits are occupied as follows: on ignition of the vehicle, voltage is provided across voltage plus ignition leads (101 and 109) of each of the seat belt usage indicator circuits, and the common voltage plus ignition lead (143′″). Therefore the plurality of seat belt usage indicator circuits are all provided power from the ignition.

Element 100′ represents the grounding output of the seat occupied sensor for a first seat. When the first seat is occupied, the seat occupied sensor (100′) will close and thus close and pull the voltage at the junction of resistors (104′ and 105′) to ground. The grounding of the voltage at the junction of resistors (104′ and 105′) will result in biasing the transistor (106′) to the ON, or conducting state. The current through transistor (106′) is limited by resistor (107′) to prevent damage to the transistor (106′). When transistor (106′) is turned on, it provides biasing voltage to the transistor (161′) through resistors (127′ and 162′). This bias voltage turns on transistor (161′) which will result in it conducting current to ground through the external indicator light (141′″).

The external indicator light (141′″) in this embodiment is activated through similar mechanisms when any occupant is seated in any of the seats. To ensure proper operation of the external indicator light (141′″), a current limiting resistor (142′″) is provided.

As other occupants enter the vehicle and seat themselves in any of the remaining seats, the external indicator light (141′″) will remain lit. This external indicator light will remain lit until each occupied seat in the vehicle have placed the seat belt in the proper operational mode.

The external indicator light (141′″) is positioned on the external of vehicle so as to be easily seen by external viewers such as law enforcement such that an easy determination of proper seat belt usage can be made and appropriate action to enforce local, state, or federal laws can be performed. To ensure that the external indicator light (141′″) does not accidentally illuminate, each seat belt usage indicator circuit is provided with a resistor (128) which therethrough provides an additional low current path to ground to ensure that each usage circuits second transistor (161) is biased OFF if the first transistor of each circuit is in the OFF state to thereby prevent accidental activation of the indicator light.

When the seat belt that corresponds with the activated seat occupancy sensor (100) is pulled from its retractor, the sensor represented by each seat belt reel sensor (121) will close and pull the voltage at the junction of resistors (127, 128, and 162) to ground through each seat belt usage indicator circuits blocking diode (124). This will result in the second transistor (161) of each seat belt usage indicator circuit being biased to the “OFF” state which will result in the external indicator light (141′″) being turned off.

As shown in FIGS. 2A and 2B there is a circuit with a plurality of seat belt usage indicator systems wired one for each seat. In practice there could be one seat wired or two, three, four . . . In the embodiment shown the plurality of seats each share a common indicator light circuit including a third voltage plus ignition lead (143′″), an external indicator light (141′″) and a fifth resistor (143′″).

When the ignition is engaged, voltage will be provided across voltage leads (101′, 101″, 101′″, and 101′″); (109′, 109″, 109′″, 109′″; and 143′″). The circuits are grounded out across first grounding lead (103′, 103″, 103′″, 103′″), second grounding lead (123′, 123″, 123′″, 123′″), third grounding lead (128′, 128″, 128′″, 128′″) and fourth grounding lead (163′, 163″, 163′″, 163′″).

When an occupant sits in a first seat, the seat occupied sensor (100′) will be closed which will pull the junction of a first resistor (104′) and a second resistor (105′) to ground.

This grounding of first and second resistors (104′ and 105′), respectively, will bias first transistor (106′) which is optionally a PNP bipolar junction type transistor to an “ON state.” Therefore, current will pass through the first transistor (106′) to a third resistor (127′) and into the seat belt reel sensor circuit.

The current from the first transistor (106′) due to the seat being occupied and the ignition engaged, will provide a biasing voltage to a second transistor (161′) which is optionally an NPN bipolar junction type transistor, through the third resistor (127′) and a fourth resistor (162′). This biasing voltage turns the second transistor (161′) “ON” which will result in the second transistor (161′) conducting current to ground through external indicator light (141′″) and a fifth resistor (142′). The current passing to ground through external indicator light (141′″) will result in external indicator light (141′″) being illuminated. With external indicator light (141′″) of the indicator light circuit system active, this indicates to external viewers such as police and law enforcement personnel that a seat is occupied, the ignition is activated, and yet, no seat belt reel sensor has been activated—which indicates that the seat belt is not being used properly or accordingly to law in the operating and occupied automobile.

External indicator light (141′″) is preferably a color visible for a distance and not easily mistakable for headlights, brake lights or turn signals. The external indicator light (141′″) is preferably located on the exterior of the vehicle in plain sight of a law enforcement personnel and other motorists. On sight, law enforcement officials can then take appropriate action to enforce local laws concerning seat belt use and thus, the overall safety of the roadways is enhanced.

When the external indicator light (141′″) is activated as required that the seat belt associated with the occupied seat be used to deactivate the seat belt usage indicator system (1), thus preventing the driver of the vehicle from purposely bypassing the system by other means.

In the subject patent application, the circuit focuses on the seat belt reel sensor (121′) of the seat belt corresponding to the occupied seat, the system is not able to be defeated by simple tampering. Deactivation of external indicator light (141′″) requires the activation of a seat belt of the seat belt reel sensor (121′) associated with the seat that is currently occupied. Thus, extending the passenger seat into engagement with the driver's buckle will have no effect. Similarly, wedging a piece of metal into the buckle, which could disable a traditional Hall sensor in a buckle head type system—will have no effect herein. The subject system could optionally provide for a set range of extension necessary from the seat belt reel sensor (121′) such that the belt must be extended between the minimum/maximum range to deactivate the external indicator light (141′″). Such a configuration could prohibit a user from simply leaving his seat belt extended and plugged into the buckle receptacle and sitting on the seat belt. Therefore, this system has enhanced resistance to tampering and will provide a more reliable system.

To ensure that this external indicator light (141′″) is activated only when it is intended to be activated and does not trigger on false positives, a plurality of surge absorbing devices are provided. The first absorbing device is shown as element (102′) which is coupled in parallel relation with the first seat occupied sensor (100′). Optionally, the surge absorbing device (102′) is a transient voltage suppression diode (transorb).

A second surge absorbing device (122′) is coupled in parallel relation to the seat belt reel sensor (121′). The second surge suppression/absorption device could also optionally be a transient voltage suppression diode (transorb).

The first and second surge absorbing devices (102′ and 122′ respectively) are intended to protect the circuitry from any voltage spikes that may occur due to static electricity or other disturbances in the vehicle's electrical system and therefore ensure continued reliable operation.

To further protect the system, the current through the first resistor (106′) is limited by a sixth resistor (107′) to prevent damage to the device. The sixth resistor (107′) is disposed inline between the second voltage plus ignition lead (109′) and the first transistor (106′).

A further current limiting resistor, the fifth resistor (142′) is provided for the indicator light circuit disposed inline between the second transistor (161′) and external indicator light (141′″) coupled in series relation thereto. A seventh resistor (128′) provides an additional low current path to ground to ensure that the second transistor (161′) is biased “OFF” if the first transistor (106′) is in the “OFF” state to thereby prevent accidental activation of the external indicator light (141′″) of the indicator light circuit.

When the seat belt corresponding to the occupied seat is pulled from its retractor reel a seat belt reel sensor (121′) will close and pull the voltage at the junction of the third resistor (127′), fourth resistor (162′), and the seventh resistor (128′) to ground through a blocking diode (124′) provided inline and coupled in series relation to the seat belt reel sensor (121′) and the second series absorbing device (122′).

This will result in the second transistor (161′) being biased to the “OFF state” which will in turn result in external indicator light (141′″) of the indicator light circuit being deactivated. Thus, in normal operation when the ignition is engaged, the seat is occupied, and the seat belt has been extended from the seat belt reel corresponding to the occupied seat, there is no light indicia. The absence of illumination of external indicator light (141′″) indicates that the seat belt is not being used improperly. Oppositely, when the usage indicator light is illuminated, this indicates that there is improper seat belt usage.

If the vehicle occupant attempts to bypass the seat belt usage indicator system (1) by inserting a seatbelt from an unoccupied passenger seat in the driver side buckle or using some other type of device in an attempt to defeat the system, the second transistor (161′) will still be biased “ON” because seat belt reel sensor (121′), corresponding to the seat occupied sensor (100′) has not been closed. Therefore, this tampering will still result in the external indicator light (141′″) being “ON”.

Optionally, a second user can enter a second seat. If external indicator light (143′″) was in the “OFF” state because the first user was seated and did extend his seat belt, on the entrance of a second passenger, and the triggering of a corresponding seat occupied sensor circuit (100″), the external indicator light (143′″) would now be illuminated. As the user sits into the second seat, the seat occupied sensor (100″) of the seat occupied sensor circuit will be closed which will pull the junction of a first resistor (104″) and a second resistor (105″) to ground.

This grounding of first and second resistors (104″) and (105″), respectively, will bias a first transistor (106″). Therefore, current will pass through the first transistor (106″) to a third transistor (127″) and into the seat belt reel sensor circuit.

The current from the first transistor (106″), due to the seat being occupied and the ignition engaged, will provide a biasing voltage to a second transistor (161″), through the third resistor (127″) and a fourth resistor (162″).

This biasing voltage turns a second transistor (161″) “ON”, which will result in the second transistor (161″) conducting current to ground through external indicator light (141′″) and a fifth resistor (142′″). The current passing to ground through external indicator light (141′″) will result in external indicator light (141′″) being illuminated.

With external indicator light (141′″) of the indicator light circuit system active, this indicates to external viewers such as police or law enforcement personnel that a seat is occupied, the ignition is activated, but at least one seat belt reel sensor has not been activated.

To ensure that this external indicator light (141′″) is active only when it is intended to be activated, and does not trigger on false positives, a plurality of surge absorbing devices are provided. The surge absorbing device is shown as element (102″) which is coupled in parallel relation with the first seat occupied sensor (100″). A second surge absorbing device (122″) is coupled in parallel relation to the seat belt reel sensor (121″). To further protect the system, the current through the first transistor (106″) is limited by a sixth resistor (107″) to prevent damage to the device. The sixth resistor (107″) is disposed inline between the second voltage plus ignition lead (109″) and the first transistor (106″). A seventh resistor (128″) provides an additional low current path to ground to ensure that the second transistor (161″) is biased “OFF” if the first transistor (106″) is in the “OFF” state to thereby prevent accidental activation of the external indicator light (141′″).

When the seat belt corresponding to the second seat is pulled from its retractor reel, a seat belt reel sensor (121″) will close and pull the voltage at the junction of the third resistor (127″), fourth resistor (162″), and a seventh resistor (128″) to ground through a blocking diode (124″) which is provided inline and coupled in series relation to the seat belt reel sensor (121″) and the second absorbing device (122″).

This grounding will result in the second transistor (161″) being biased in the “OFF” state which will in turn result in external indicator light (141′″) of the indicator light circuit being deactivated.

Optionally, a third occupant will enter and sit on the third seat. Assuming that passengers 1 and 2 are seated and the seat belt is extended properly such that the external indicator light (141′″) is “OFF”, when the third passenger sits, they will activate the seat occupied sensor (100′″) of the third seat. This will pull the junction of a first resistor (104′″) and a second resistor (105′″) to ground. This grounding, will bias a first transistor (106′″) to an “ON” state. As current passes through the first transistor (106′″) to a third resistor (127′″) and into the seat belt reel sensor circuit, the current from the first transistor (106′″) will provide a biasing voltage to a second transistor (161′″), through the third resistor (127′″) and a fourth resistor (162′″).

Second transistor (161′″) in the “ON state” and will conduct current to ground through external indicator light (141′″) and a fifth resistor (142′″). As there is now at least one occupant of the vehicle that does not have a corresponding seat belt extended, the indicator light (141′″) will again be illuminated. It is required that the seat belt associated with the newly occupied seat 3 be used to deactivate the seat belt usage indicator system (1).

A plurality of surge absorbing devices are provided to ensure reliable and accurate operation. First surge absorbing device (102′″) is coupled in parallel relation with the first seat occupied sensor (100′″). A second surge absorbing device (122′″) is coupled in parallel relation to the seat belt reel sensor (121′″) of the third seat. The current flowing through the first transistor (106′″) is limited by a sixth resistor (107′″) to prevent damage to the device. The sixth resistor (107′″) is disposed inline between the second voltage plus ignition lead (109′″) and the first transistor (106′″).

A further current limiting resistor, the fifth resistor (142′″) is provided for the indicator light circuit, disposed inline between the second transistor (161′″) and external indicator light (141′″) coupled in series relation thereto. A seventh resistor (128′″) provides an additional low current path to ground to ensure that the second transistor (161′″) is biased “OFF” if the first transistor (106′″) is in the “OFF” state to thereby prevent accidental activation of the external indicator light (141′″).

When the third seat belt, which corresponds to the occupied third seat, is pulled from its retractor reel, a seat belt reel sensor (121′″) will close and pull the voltage at the junction of the third resistor (127′″), fourth resistor (162′″), and the seventh resistor (128′″) to ground through a blocking diode (124′″) which is provided inline and coupled in series relation to the seat belt reel sensor (121′″) of the third seat and the surge absorbing device (122′″).

This will result in the second transistor (161′″) being biased in the “OFF” state which will in turn result in external indicator light (141′″) of the indicator light circuit being deactivated.

As there are now three seated passengers which all have respective seat belts engaged, the external indicator light (141′″) is deactivated. On entrance of a fourth passenger, the seat occupied sensor of the fourth seat (100′″) of the seat occupied sensor circuit will be closed which will pull the junction of a first resistor (104′″) and a second resistor (105′″) to ground.

This grounding of first and second resistors (104′″) and (105′″) respectively, will bias a first transistor (106′″) to an “ON” state. Therefore, current will pass through the first transistor (106′″) to a third resistor (127′″) and the seat belt reel sensor circuit. The current from the first transistor (106′″) due to the seat being occupied and the ignition engaged, will provide a biasing voltage to a second transistor (161′″) through the third resistor (127′″) and a fourth resistor (162′″).

This biasing voltage turns the second transistor (161′″) “ON” which will result in the second transistor (161′″) conducting current to ground through external indicator light (141′″) and a fifth resistor (142′″). The current passing to ground through external indicator light (141′″) will result in external indicator light (141′″) being illuminated. To deactivate the external indicator light (141′″), it is required that the fourth passenger activate or extend the fourth seat belt which corresponds with the fourth seat. By extending the seat belt, the seat belt reel sensor (121′″) associated with the fourth seat will be closed.

To ensure the accuracy and reliability of this system, external indicator light (141′″) is provided with a plurality of surge absorbing devices. The first surge absorbing device is element (102′″) which is coupled in parallel relation with the first seat occupied sensor (100′″) of the fourth seat. A second surge absorbing device (122′″) is coupled in parallel relation to the seat belt reel sensor (121′″) of the fourth seat. Both first and second surge absorbing devices are intended to protect the circuitry from any voltage spikes that may occur due to static electricity or other disturbances in the vehicle's electrical system and therefore ensure continued reliable operation.

To further protect the system, the current to the first transistor (106′″) is limited by a sixth resistor (107′″) to prevent damage to the device. The sixth resistor (107′″) is disposed inline between the second voltage plus ignition lead (109′″) in the first transistor (106′″).

A further current limiting resistor, the fifth resistor (142′″) is provided for the indicator light circuit disposed inline between the second transistor (161′″) and the external indicator light (141′″) coupled in series relation thereto. A seventh resistor (128′″) provides an additional path to ground to ensure that the second transistor (161′″) is biased “OFF” if the first transistor (106′″) is in the “OFF” state to thereby prevent accidental activation of the external indicator light (141′″) of the indicator light circuit.

When the fourth seat belt, which corresponds to the now occupied fourth seat is pulled from its retractor reel, a seat belt reel sensor (121′″) will close and pull the voltage to the junction of the third resistor (127′″), fourth resistor (162′″), and seventh resistor (128′″) to ground through a blocking diode (124′″) provided inline and coupled in series relation to the seat belt reel sensor (121′″) and the second surge absorbing device (122′″).

This will result in the second transistor (161′″) being biased to the “OFF state” which will in turn result in external indicator light (141′″) of the indicator light circuit being deactivated.

Again, this is merely an exemplary situation. In practice, one of ordinary skill in the art will realize that passengers and occupants of the car can enter in any order and still retain functionality of the system.

It will be appreciated by those skilled in the art that changes could be made to the embodiments described above without departing from the broad inventive concept thereof. It is understood, therefore that this invention is not limited to the particular embodiments disclosed, but is intended to cover modifications within the spirit and scope of the present invention as defined by the appended Claims.

What is claimed is:

1. A vehicle seatbelt usage indicator system comprising:
(a) a seat occupancy sensor circuit for sensing occupancy of a vehicle seat;
(b) a seatbelt reel sensor circuit electrically coupled to said seat occupancy sensor circuit for determining extension of a seatbelt to an operating position; and,
(c) a light control circuit electrically coupled to said seat occupancy sensor circuit and said seatbelt reel sensor circuit for illuminating a vehicle externally mounted light when said seat occupancy sensor circuit senses an occupancy of said vehicle seat and said seatbelt reel sensor circuit senses said seat belt in a non-operating position.

2. The external vehicle seatbelt usage indicator system as defined in claim 1, wherein the seat occupancy sensor circuit includes:
a seat switch for closing the seat occupancy circuit when said seat is occupied, said seat occupancy sensor circuit being electrically coupled to an ignition system of said vehicle through at least one ignition lead.

3. The external vehicle seatbelt usage indicator system as defined in claim 2, wherein said seat switch is a pressure switch.

4. The external vehicle seatbelt usage indicator system as defined in claim 2, wherein said seat switch is an open collector type Hall sensor.

5. The external vehicle seatbelt usage indicator system as defined in claim 2, wherein said seat occupancy sensor circuit includes:
a first surge absorbing device coupled to said seat switch in parallel relation, said first surge absorbing device and said seat switch being coupled to said ignition system through said at least one ignition lead.

6. The external vehicle seatbelt usage indicator system as defined in claim 2, further including a plurality of ignition leads for coupling said seat occupancy sensor circuit, seatbelt reel sensor circuit, and said light control circuit to said vehicle ignition, wherein each ignition lead includes a respective resistor disposed inline for reducing current values thereby preventing excessive electrical current to said seat occupancy sensor circuit, said seatbelt reel sensor circuit, and said light control circuit.

7. The external vehicle seatbelt usage indicator system as defined in claim 5, wherein said first surge absorbing device is a transient voltage suppression diode.

8. The external vehicle seatbelt usage indicator system as defined in claim 1, wherein the seat belt reel sensor circuit includes a seat belt reel sensor switch for closing the seat belt reel sensor circuit when said seatbelt is extended to an operating position from said seat belt reel.

9. The external vehicle seatbelt usage indicator system as defined in claim 8, wherein the seat belt reel sensor switch is an open collector type Hall effect sensor.

10. The external vehicle seatbelt usage indicator system as defined in claim 1, wherein said vehicle externally mounted light is a light emitting diode (LED).

11. The external vehicle seatbelt usage indicator system as defined in claim 7, wherein said seat belt reel sensor circuit further includes:
a second surge absorbing device coupled to said seat belt reel sensor switch in parallel relation, said surge absorbing device and said seat belt reel sensor switch being coupled to said ignition system through said at least one ignition lead.

12. The external vehicle seatbelt usage indicator system as defined in claim 7, wherein said seat belt reel sensor circuit further includes a low current path to ground having a resistor coupled in series relation to said seat belt reel sensor circuit.

13. The external vehicle seatbelt usage indicator system as defined in claim 11, wherein said second surge absorbing device of said seat belt reel sensor circuit is a transient voltage suppression diode.

14. The external vehicle seatbelt usage indicator system as defined in claim 1, wherein the light control circuit includes a current limiting resistor coupled in series relation to said externally mounted light.

15. The external vehicle seatbelt usage indicator system as defined in claim 1, wherein said seat occupancy sensor circuit and said seatbelt reel sensor circuit are electrically coupled to said light control circuit through a first transistor in series relation to said seat occupancy sensor circuit and said seat belt reel sensor circuit.

16. The external vehicle seatbelt usage indicator system as defined in claim 15, wherein said first transistor is a bipolar junction transistor.

17. The external vehicle seatbelt usage indicator system as defined in claim 16, wherein said first transistor is an NPN type bipolar junction transistor.

18. The external vehicle seatbelt usage indicator system as defined in claim 1, wherein said seat occupancy sensor circuit is coupled to said seatbelt reel sensor circuit through a second transistor, wherein said second transistor is a bipolar junction transistor.

19. The external vehicle seatbelt usage indicator system as defined in claim 18, wherein said second transistor is a PNP type bipolar junction transistor.

20. A vehicle seatbelt usage indicator system comprising:
(a) a plurality of seat occupancy sensor circuits, each for sensing occupancy of a corresponding vehicle seat;
(b) a plurality of seatbelt reel sensor circuits, each electrically coupled to a respective one of said plurality of seat occupancy sensor circuits for determining extension of a seatbelt to an operating position; and,
(c) a light control circuit electrically coupled to said seat occupancy sensor circuits and said seatbelt reel sensor circuits for illuminating a vehicle externally mounted light when any one of said seat occupancy sensor circuit senses an occupancy of said vehicle seat and a corresponding one of said seatbelt reel sensor circuits senses a corresponding seat belt in a non-operating position.
